(19) United States
(12) Patent Application Publication
(10) Pub. No.: US 2024/0075493 A1
(43) Pub. Date: Mar. 7, 2024

(54) THREAD SEALING COMPOUND DISPENSING APPARATUS

(71) Applicant: SAUDI ARABIAN OIL COMPANY, Dhahran (SA)

(72) Inventors: Ali S. Abu Alsaud, Dhahran (SA); Suliman M. Azzouni, Dhahran (SA)

(73) Assignee: SAUDI ARABIAN OIL COMPANY, Dhahran (SA)

(21) Appl. No.: 17/929,492

(22) Filed: Sep. 2, 2022

(51) Int. Cl. B05C 1/02; B05D 1/28

(52) U.S. Cl. CPC B05C 1/027; B05D 1/28

(57) ABSTRACT

A fluid dispensing apparatus is claimed. The fluid dispensing apparatus includes a body, where the body is hollow and has an interior cavity extending axially through the body, and where the interior cavity has a first end and a second end. The fluid dispensing apparatus also includes a cap sealing the first end, a connection mechanism joining the cap and the body, and an applicator assembly disposed within the interior cavity. The applicator assembly includes an applicator disposed at the first end, the applicator having at least one outlet, and a piston connected to the applicator, where the piston comprises a head disposed within the interior cavity and a plunger rod extending from the head and through the second end of the interior cavity. The fluid dispensing apparatus further includes a pedal connected to the plunger rod.

### BACKGROUND

In the oil and gas industry, there are many situations in which threaded connections are required for the joining of tubulars. In such situations, it is advantageous to apply a thread sealing compound, colloquially referred to as pipe dope, to threaded connections in order to ensure that joints are leak-proof. Pipe dope fills any voids which exist between pipe threads, creating a seal between tubular sections. Furthermore, pipe dope also acts as a lubricant, preventing deformation of pipe threads while applying the high torque required to properly secure tubular sections together.

Typically, pipe dope is applied manually to threaded tubular connections by rig hands. However, such application methods can lead to the application of excess pipe dope to threaded connections, which can cause blockages of drill bit nozzles downhole. In such situations, it would be necessary to remove the drill string from the well to remove the blockage, which leads to unproductive time for the well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a fluid dispensing apparatus. The fluid dispensing apparatus may include a body, where the body is hollow and has an interior cavity extending axially through the body, and where the interior cavity has a first end and a second end. The fluid dispensing apparatus may also include a cap sealing the first end, a connection mechanism joining the cap and the body, and an applicator assembly disposed within the interior cavity. The applicator assembly may include an applicator disposed at the first end, the applicator having at least one outlet, and a piston connected to the applicator, where the piston may comprise a head disposed within the interior cavity and a plunger rod extending from the head and through the second end of the interior cavity. The fluid dispensing apparatus may further include a pedal connected to the plunger rod.

In another aspect, embodiments disclosed herein relate to a fluid dispensing apparatus. The fluid dispensing apparatus may include a body comprising an interior cavity extending axially through the body, an applicator disposed at a first end of the body, the applicator having at least one outlet, and a piston. The piston may include a head disposed within the interior cavity, and a plunger rod extending from the head and through a second end of the body. The fluid displacement apparatus may further include a pedal assembly connected to the plunger rod.

In yet another aspect, embodiments disclosed herein relate to a method of applying a compound to a threaded pipe. The method may include filling a fluid dispensing apparatus with the compound, wherein the fluid dispensing apparatus comprises a body comprising an interior cavity, and an applicator positioned at or proximate to a first end of the body, wherein the applicator comprises at least one outlet. The body may also include a piston comprising a head disposed within the interior cavity and a plunger rod extending from the head and out of a second end of the body, opposite the applicator. The fluid dispensing apparatus may also include a pedal connected to the plunger rod. The compound may be filled into a reservoir formed between the head of the piston and the applicator. The method may further include squeezing the pedal a number of times, where each squeeze of the pedal moves the piston a distance through the interior cavity, dispensing the compound from the reservoir and out of the at least one outlet of the applicator, wherein the compound is dispensed in an amount proportional to the number of times the pedal is squeezed, and applying the compound to the threaded pipe.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The size and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A-1B show a fluid displacement apparatus in accordance with one or more embodiments.

FIG. 2A-2B show a fluid displacement apparatus in accordance with one or more embodiments.

FIG. 3 shows a fluid displacement apparatus in accordance with one or more embodiments.

FIG. 4A-4B show a fluid displacement apparatus in accordance with one or more embodiments.

FIG. 5 shows a fluid displacement apparatus in accordance with one or more embodiments.

FIG. 6 shows a flowchart of a method in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

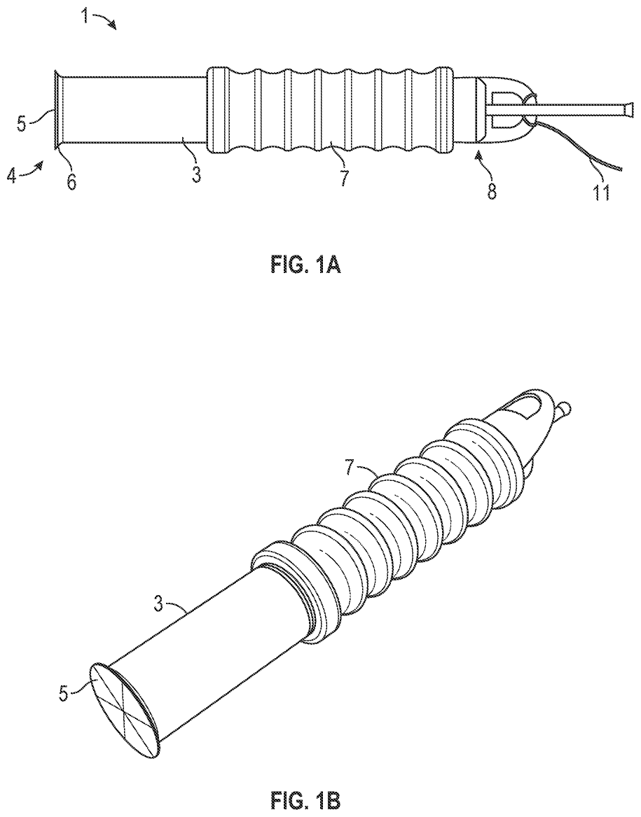

In the following description of FIGS. 1A-5, any component described with regard to a figure, in various embodiments disclosed herein, may be equivalent to or similar to one or more like-named components (in structure or function) described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

In one aspect, embodiments disclosed herein relate to a fluid displacement apparatus which may be utilized to apply an appropriate amount of thread sealing compound to a threaded connection between two tubular sections. A fluid displacement apparatus according to embodiments disclosed herein may prevent blockages in drilling nozzle bits due to excess application of thread sealing compound, which may in turn reduce unproductive time of the well. In another aspect, embodiments disclosed herein relate to a method of applying a thread sealing compound to a threaded connection with a fluid displacement apparatus.

FIGS. 1A-1B illustrate a fluid displacement apparatus 1 in accordance with one or more embodiments. The fluid displacement apparatus may be filled with a thread sealing compound or other fluid, and a user may hold and maneuver the filled fluid displacement apparatus around a threaded connection to dispense the fluid from the fluid displacement apparatus onto the threaded connection.

In one or more embodiments, the fluid displacement apparatus 1 may include a body 3 with a cap 5 disposed at a first end 4 of the body 3. The cap 5 may be connected to the body 3 via a connection mechanism 6. In one or more embodiments, the connection mechanism 6 may be a hinge. In some embodiments, a grip 7 may surround the body 3. The grip 7 may allow for easier handling of the fluid displacement apparatus 1. A thread sealing compound may be filled into an interior of the body 3 (e.g., through an opening at an end of the body 3). For example, in some embodiments, a port may be provided at the second end 8 of the body 3 to provide access to the interior of the body 3. The port may be opened (e.g., via a lid or cap threadably connected to the port) to allow a sealing compound to be injected through the port and into the interior of the body 3. The sealing compound may be stored in a reservoir in an interior cavity of the body 3 and may eventually be dispensed from the reservoir via an applicator of the fluid displacement apparatus 1.

A piston 9 may extend from the interior of the body 3 through the second end 8 of the body 3. When a fluid (e.g., a thread sealing compound) is filled within the interior of the body 3, the piston 9 may be in direct or indirect contact with the fluid, such that the piston 9 may be used to exert a dispensing force on the fluid to dispense the fluid from the fluid displacement apparatus 1. In one or more embodiments, the body 3 may also have a strap 11 secured to the second end 8, which may be used, for example, to tether the fluid displacement apparatus 1 to another object.

The fluid displacement apparatus 1 in FIGS. 1A-1B is shown in a closed configuration, where the cap 5 is closed. When the fluid displacement apparatus 1 is ready to be used, the cap 5 may be opened, and a fluid stored within the body 3 may be dispensed through the first end 4 of the body 3 by moving the piston 9 in a direction from the second end 8 toward the first end 4.

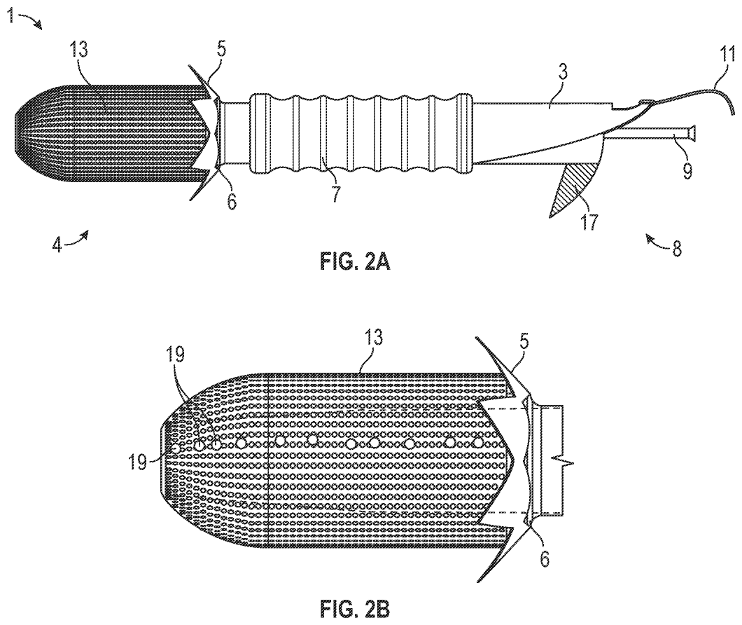

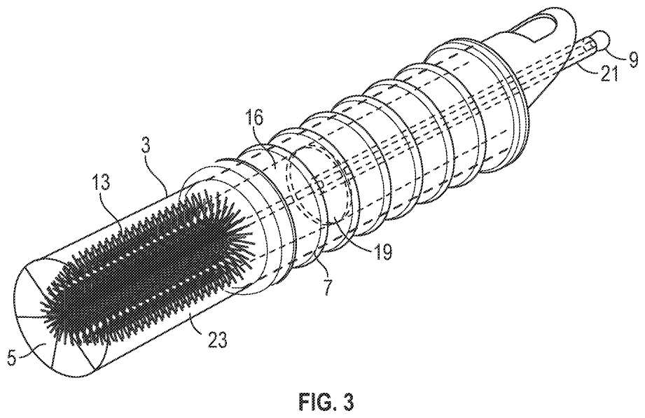

FIGS. 2A-2B show a fluid displacement apparatus 1 in an open configuration in accordance with one or more embodiments, where a cap 5 of the fluid displacement apparatus 1 may be opened to allow for a fluid to be dispensed. In one or more embodiments, the grip 7 may be used to transition the fluid displacement apparatus 1 from a closed configuration, as shown in FIGS. 1A-1B, to an open configuration, shown in FIGS. 2A-2B. More specifically, the grip 7 may be movable along the body 3, such that pushing the grip 7 towards the cap 5 causes the cap 5 to open (e.g., where the cap opening mechanism may be connected to or come in contact with the grip 7 such that the cap opens as the grip moves).

In some embodiments, the grip 7 may be operatively connected to an applicator assembly held within the interior of the body 3, such that axial movement of the grip 7 along the outside of the body 3 axially moves the applicator assembly within the body 3. In such embodiments, as described in more detail below, from a closed configuration (e.g., as shown in FIGS. 1A-B), the grip 7 may be slid in a direction from the second end 8 toward the first end 4, where sliding the grip 7 also axially moves the connected applicator assembly to push through the cap 5 at the first end 4 to move the fluid displacement apparatus to the open configuration shown in FIG. 2A. In some embodiments, a grip 7 may be operatively connected to an applicator assembly by a connection bridge that extends from the grip 7, through a slot in the body 3, to the applicator assembly.

In one or more embodiments, the body 3 of the fluid displacement apparatus 1 may be hollow, where an interior cavity (not shown) extends axially through the body 3 from the first end 4 to the second end 8 of the body 3. In a closed configuration, as shown in FIGS. 1A-B, an applicator assembly, including an applicator 13, may be held within the interior cavity, and in an open configuration, as shown in FIGS. 2A-B, the applicator 13 may extend outwardly from the first end 4 of the body 3. The grip 7 may be connected to the applicator assembly such that moving the grip 7 along the body 3 towards the cap 5 may also extend the applicator 13 outwardly from the first end 4 of the body 3. In one or more embodiments, the applicator 13 may be a rounded brush with bristles extending radially from a brush head. However, there are other embodiments in which the applicator 13 may be a different shape. For example, in some embodiments, the applicator 13 may be a brush with straight bristles extending in a single direction from one side of the applicator 13.

In one or more embodiments, the applicator 13 may have bristles for applying thread sealing compound. However, there are additional embodiments where the applicator 13 is composed of different materials, such as a foam layer positioned around the applicator 13 in place of the bristles.

According to embodiments of the present disclosure, the applicator 13 may be held inside the body 3 of the fluid displacement apparatus 1 when the fluid displacement apparatus 1 is in a closed configuration, with the cap 5 closed. In such embodiments, the applicator 13 may be positioned within and movable within the interior cavity and may be extended past the cap 5 from the first end 4 of the body 3, as shown in FIG. 2A, when the cap 5 is open.

A connection mechanism 6 may facilitate the joining of the cap 5 to the body 3. In order to allow the applicator 13 to extend from the interior cavity, the cap 5 may open about the connection mechanism 6. In one or more embodiments, the connection mechanism 6 may comprise a plurality of hinges, such that the cap 5 may split into a number of sections, where each section is movable about its own hinge. In other embodiments, the connection mechanism 6 may comprise only a single hinge and the cap 5 may swing open in a single piece.

A pedal 17 may be assembled to the fluid displacement apparatus 1. In one or more embodiments, the pedal 17 may be a pedal assembly, which may include a pedal lever connected to the second end 8 of the body 3. A spring (not shown) may be positioned between the pedal lever and the body 3. The pedal lever may also include or be connected to a gripping portion, which may selectively grip a plunger rod portion of the piston 9 as the pedal 17 is operated. In operation, when the pedal 17 is squeezed, the gripping portion contacts and moves the plunger rod portion of the piston 9, and when the pedal 17 is released, the spring pushes the pedal 17 outwardly back to its initial position prior to being squeezed. In one or more embodiments, the pedal 17 may be manually operated by an operator.

FIG. 2B shows an applicator 13 of a fluid displacement apparatus 1 in accordance with one or more embodiments. The applicator 13 may have at least one outlet 19 formed through the applicator body and in fluid communication with a fluid chamber extending through the interior of the applicator 13. The fluid chamber may act as a reservoir to hold a fluid (e.g., sealing compound) within the applicator 13. The fluid chamber may extend a length greater than the applicator 13, such that the fluid chamber may extend through the applicator 13 and into the interior cavity of the body 3. Fluid stored in the fluid chamber may be pushed through the applicator 13 and out of at least one outlet 19 formed through the applicator body. In one or more embodiments, the applicator 13 may have numerous outlets 19. The outlet(s) 19 may be formed through one or more surfaces of the applicator body. For example, an applicator body may have a generally tubular shape (as shown in FIG. 2B) formed by a rounded surface having outlets 19 formed around the rounded surface. Bristles or other spreading layer (e.g., a foam layer, a cloth, or other fibrous layer) may be attached around the surface of the applicator body. As a compound is ejected through the outlets 19 formed around the applicator surface, the compound may be caught by the spreading layer. As the compound embedded spreading layer is moved around a threaded connection, the spreading layer (e.g., bristles) may spread the compound evenly around the threaded connection.

FIG. 3 is a schematic of a fluid displacement apparatus 1 in accordance with one or more embodiments, which shows the interior of the fluid displacement apparatus 1. The fluid displacement apparatus 1 is shown in a closed configuration, where an applicator assembly including an applicator 13 and a fluid chamber 16 is enclosed by the cap 5 in the interior cavity 23 of the fluid displacement apparatus 1. In one or more embodiments, the fluid chamber 16 may be disposed within the interior cavity 23 and extend through the interior of the applicator 13. A piston 9 having a head 19 and a plunger rod 21 is assembled to the body 3 of the fluid displacement apparatus 1. The head 19 may be located within the fluid chamber 16 (and thus also within the interior cavity 23 of the body 3), proximate the applicator 13. The plunger rod 21 may extend from the head 19 through the interior cavity 23 and out of the second end 8 of the body 3. The fluid chamber 16 may form a reservoir to hold fluid between the applicator 13 and the piston head 19.

When the fluid displacement apparatus 1 is in a closed configuration, the applicator assembly, including the applicator 13 and the fluid chamber 16, may be enclosed within the interior cavity 23 of the apparatus body 3. A grip 7 provided around an exterior of the body 3 may be operatively connected to the applicator assembly, such that when the grip 7 is slid axially along the body 3, the applicator assembly may also move axially through the interior of the body 3. In some embodiments, a grip 7 may be operatively connected to the fluid chamber 16 of the applicator assembly via a connection bridge extending through a slot formed along a partial length of the body 3. The grip 7 may be slid in a direction toward the cap 5 to push a front end of the applicator 13 through the cap 5 to open the cap 5 and extend the applicator 13 completely out of the interior of the body 3 to move the fluid displacement apparatus 1 in an open configuration (e.g., as shown in FIG. 2A).

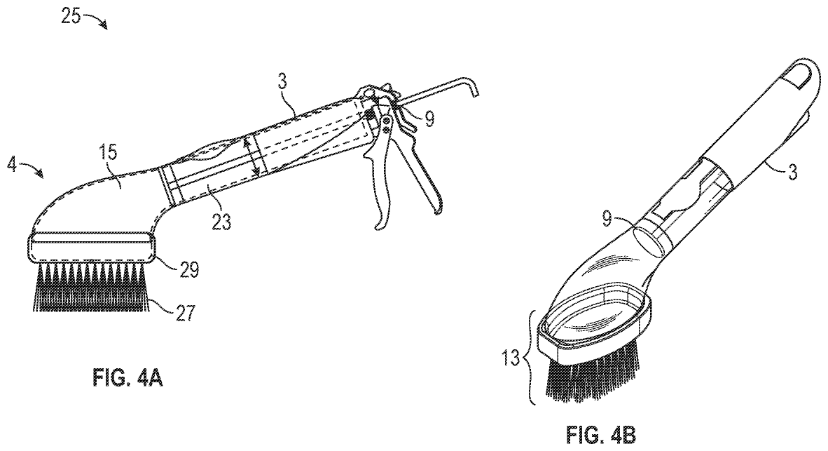

FIGS. 4A-4B show another fluid displacement apparatus 25 in accordance with one or more embodiments. In one or more embodiments, the fluid displacement apparatus 25 may have an applicator 13 fixedly secured to a first end 4 of a body 3 of the fluid displacement apparatus 25. In some embodiments, the applicator 13 may be a brush which has straight bristles 27 extending in a single direction from a surface 29 disposed at the first end 4 of the body 3. The surface 29 may have at least one outlet to allow fluid to be released through the applicator 13 from a reservoir 15 formed in the interior of the body 3. In some embodiments, an applicator may be a rounded brush that is fixedly secured to a body of a fluid displacement apparatus 25.

A piston 9 may be assembled to the body 3, such that a head of the piston 9 is disposed within an interior cavity 23 of the body 3 and a plunger rod portion of the piston 9 extends from the head to outside of the a second end of the body 3. Additionally, a fluid may be filled in a reservoir 15 portion of the interior cavity 23. The piston head may move axially through the interior cavity 23 to exert a force on fluid filled in the reservoir 15 and dispense fluid from the reservoir 15 out of the applicator 13 provided at the first end 4 of the fluid displacement apparatus 25.

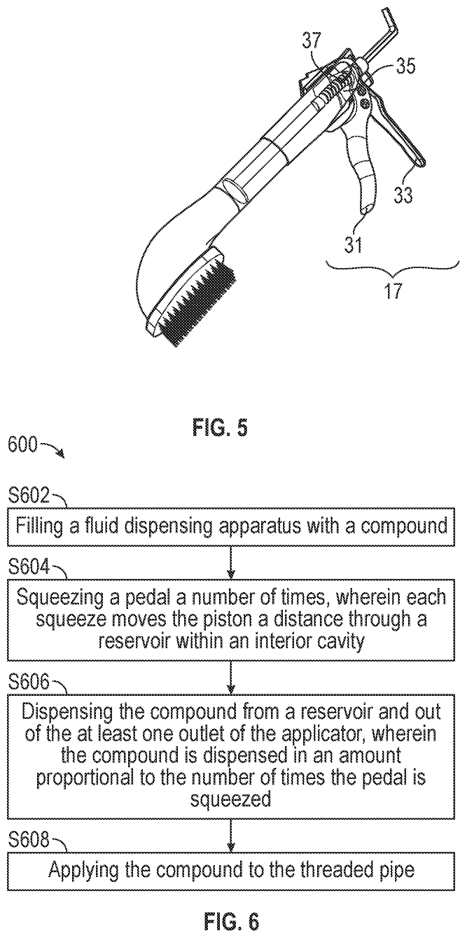

FIG. 5 illustrates another fluid displacement apparatus in accordance with one or more embodiments. More specifically, FIG. 5 shows an example of a pedal 17 provided on the fluid displacement apparatus. The pedal 17 may be connected to the plunger rod 21 of the piston 9 in the fluid displacement apparatus. The pedal 17 may include a pedal lever 31 and a pedal support structure 33 arranged in a manner which allows for the movement of the pedal lever 31 towards the pedal support structure 33. Specifically, the pedal lever 31 may be pivotably connected to the pedal support structure 33. The pedal 17 may also include a gripping portion 35, which may connect with the plunger rod 21. A spring 37 may also be positioned between the pedal support structure 33 and at least one of the pedal lever 31 and the gripping portion 35. As the pedal lever 31 is squeezed towards the pedal support structure 33, the gripping portion 35 may grip and move the plunger rod 21 and concurrently squeeze the spring 37, thereby loading the spring 37. When the pedal lever 31 is released, the gripping portion 35 may disengage from the plunger rod 21, and the loaded spring 37 may exert force to move the pedal lever 31 back to its original position. In such manner, the pedal 17 moves the plunger rod 21 of the piston 9 by a given distance.

FIG. 6 depicts a flowchart in accordance with one or more embodiments. More specifically, FIG. 6 depicts a flowchart 600 of a method for utilizing a compound application system. Further, one or more blocks in FIG. 6 may be performed by one or more components as described in FIGS. 1A-5. While the various blocks in FIG. 6 are presented and described sequentially, one of ordinary skill in the art will appreciate that some or all of the blocks may be executed in different orders, may be combined, may be omitted, and some or all of the blocks may be executed in parallel. Furthermore, the blocks may be performed actively or passively.

Initially, a fluid displacement apparatus 1 may be filled with a compound, S602. In one or more embodiments, the compound may be a thread sealing compound. The fluid displacement apparatus 1 may have a reservoir designed to hold the compound prior to use, where the reservoir may be provided within the interior cavity 23 (e.g., within a fluid chamber provided within the interior cavity or formed by the interior cavity 23), between the applicator 13 and the head 19 of the piston 9. Once the reservoir has been filled with the compound, the piston 9 may be inserted such that the head 19 seals the reservoir 15 from an opposite end of the applicator. The pedal 17 may be fitted to the plunger rod 21 before or after filling a reservoir with a compound depending on the location and operation of an opening through which the compound is injected into the reservoir. For example, in some embodiments, a reservoir may be filled with a compound via a port formed through the body 3 of the fluid displacement apparatus, where the port may be fluidly connected to the reservoir, and where the port may be opened and closed without disassembling the pedal.

In some embodiments, a fluid displacement apparatus 1 may be filled with a compound while the fluid displacement apparatus 1 is in a closed configuration, where an applicator assembly is stored in an interior of the apparatus body 3.

When a fluid displacement apparatus 1 is provided in a closed configuration, the fluid displacement apparatus 1 may be moved to an open configuration prior to its use. In one or more embodiments, moving the apparatus from a closed configuration to an open configuration may include moving a grip 7 provided on an exterior of the body 3 to move a connected applicator 13 from the interior cavity 23 to outside of the body 3. In other embodiments, the applicator 13 may be fixedly positioned at a first end 4 of the body 3.

Next, the pedal 17 may be squeezed a number of times, where each squeeze moves the piston head a given distance through the reservoir 15, S604. Moving the piston 9 through the reservoir 15 induces the dispensing of a certain volume of compound through the applicator 13, which is proportional to the given distance moved by the piston 9, S606. In such manner, the compound may be dispensed from the reservoir 15 out of the at least one outlet on the applicator 13 in a volume proportional to the number of times the pedal 17 is squeezed. Finally, the dispensed compound may then be applied to a threaded pipe connection, S608.

In one or more embodiments, the method depicted in flowchart 600 may be tailored to a tubular of a particular size. For example, for a given threaded pipe, an operator may determine the size of the threaded pipe. In one or more embodiments, the size may refer to a diameter or a circumference, for example. Based on the determined size, an amount of compound needed may be calculated. Such a calculation may ensure that an adequate amount of compound is applied to provide appropriate lubrication and sealing without inducing blockages downhole. Since each pedal squeeze dispenses a given volume of compound, an operator may then calculate the number of pedal squeezes required to dispense the required amount of compound to the selected size of threaded connection.

Further, the calculation of the required number of pedal squeezes may be repeated to standardize the number of squeezes required per tubular size. For example, to create a standardized system for determining a required number of pipe squeezes, an operator may obtain a number of threaded pipes, where each of the threaded pipes has a different diameter. The operator may then calculate a required amount of compound for each of the threaded pipes, which can be used to calculate a required number of pedal squeezes for each of the threaded pipes. For example, X₁ amount of pedal squeezes may be calculated to dispense a required amount of compound to a threaded connection having a diameter D1, X₂ amount of pedal squeezes may be calculated to dispense a required amount of compound to a threaded connection having a diameter D2, etc. As such, the operator may then create a standardized system, where a specific number of pedal squeezes are assigned to each tubular size.

Embodiments of the present disclosure may provide at least one of the following advantages. Use of a fluid dispensing apparatus allows for application of an appropriate amount of thread sealing compound to a threaded pipe connection. The fluid dispensing apparatus prevents excess thread sealing compound from creating a blockage, e.g., in downhole drill bit nozzles. Such blockages necessitate removal of the entire drill string from the well in order to clear the obstruction. Removal of a drill string from a well induces well unproductive time, which can be extremely expensive. Using a fluid dispensing apparatus as discussed herein also helps with minimizing waste of thread sealing compound. Such fluid dispensing apparatuses may also be used in many other industries in which fluid is applied to a surface.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A fluid dispensing apparatus, comprising:
a body,
wherein the body is hollow and has an interior cavity extending axially through the body, and
wherein the interior cavity has a first end and a second end;
a cap sealing the first end;
a connection mechanism joining the cap and the body;
an applicator assembly disposed within the interior cavity, wherein the applicator assembly comprises:
an applicator disposed at the first end, the applicator comprising:
a fluid chamber extending through an interior of an applicator body; and
at least one outlet formed through the applicator body and in fluid communication with the fluid chamber; and
a piston connected to the applicator, the piston comprising:
a head disposed within the fluid chamber; and
a plunger rod extending from the head and through the second end of the interior cavity; and
a pedal connected to the plunger rod.

2. The fluid dispensing apparatus of claim 1, wherein the applicator is a brush.

3. The fluid dispensing apparatus of claim 2, wherein the brush is rounded.

4. The fluid dispensing apparatus of claim 2, wherein the brush comprises straight bristles extending in a single direction.

5. The fluid dispensing apparatus of claim 1, wherein a thread sealing compound is disposed within the fluid chamber between the applicator body and the head of the piston.

6. The fluid dispensing apparatus of claim 1, wherein the pedal is manually operated.

7. The fluid dispensing apparatus of claim 1, wherein the connection mechanism is a hinge.

8. The fluid dispensing apparatus of claim 1, wherein the applicator assembly is movable within the interior cavity and the applicator is extendable out of the first end of the interior cavity.

9. A fluid dispensing apparatus, comprising:
a body comprising an interior cavity extending axially through the body;
an applicator disposed at a first end of the body, the applicator having at least one outlet;
a piston, comprising:
a head disposed within the interior cavity; and
a plunger rod extending from the head and through a second end of the body; and
a pedal assembly connected to the plunger rod.

10. The fluid dispensing apparatus of claim 9, wherein the applicator is a brush having bristles extending in a single direction from one side of the applicator.

11. The fluid dispensing apparatus of claim 9, wherein the applicator is a rounded brush having bristles extending radially from a brush head.

12. The fluid dispensing apparatus of claim 9, wherein the pedal assembly comprises:
a gripping portion that selectively grips the plunger rod;
a pedal lever connected to the gripping portion;
a pedal support structure, wherein the pedal lever is pivotably connected to the pedal support structure; and
at least one spring positioned between the pedal support structure and at least one of the gripping portion and the pedal lever.

13. The fluid dispensing apparatus of claim 9, wherein the pedal assembly comprises:
a pedal lever pivotably connected to the second end of the body, wherein the pedal lever comprises a gripping portion that selectively grips the plunger rod; and
a spring positioned between the pedal lever and the body.

14. A method of applying a compound to a threaded pipe, comprising:
filling a fluid dispensing apparatus with the compound, wherein the fluid dispensing apparatus comprises:
a body comprising an interior cavity,
an applicator positioned at or proximate to a first end of the body, wherein the applicator comprises at least one outlet;
a piston comprising:
a head disposed within the interior cavity; and
a plunger rod extending from the head and out of a second end of the body, opposite the applicator; and
a pedal connected to the plunger rod,
wherein the compound is filled into a reservoir formed between the head of the piston and the applicator;
squeezing the pedal a number of times, where each squeeze of the pedal moves the piston a distance through the interior cavity;
dispensing the compound from the reservoir and out of the at least one outlet of the applicator, wherein the compound is dispensed in an amount proportional to the number of times the pedal is squeezed; and
applying the compound to the threaded pipe.

15. The method of claim 14, further comprising: further comprises:
determining a size of the threaded pipe;
calculating a required amount of compound to be applied to the threaded pipe based on the size of the threaded pipe; and
calculating a number of pedal squeezes required to dispense the required amount of compound.

16. The method of claim 14, wherein the compound is a thread sealing compound.

17. The method of claim 14, further comprising:
obtaining a plurality of threaded pipes,
wherein each of the plurality of threaded pipes has a different diameter;
calculating a required amount of compound for each of the plurality of threaded pipes;
calculating a required number of pedal squeezes required to dispense the required amount of compound for each of the plurality of threaded pipes; and
standardizing the required number of pedal squeezes for each diameter of the plurality of threaded pipes.

18. The method of claim 14, wherein the applicator is a rounded brush, wherein a grip is operatively connected to the applicator, and wherein the method further comprises moving the grip axially along the body to extend the applicator out of the interior cavity and through the first end of the body.

19. The method of claim 14, wherein the applicator is a brush fixedly positioned at the first end of the body.
